(19) United States
(12) Patent Application Publication
(10) Pub. No.: US 2025/0200327 A1
(43) Pub. Date: Jun. 19, 2025

(54) ADAPTIVE LARGE LANGUAGE MODEL TRAINING

(71) Applicant: International Business Machines Corporation, Armonk, NY (US)

(72) Inventors: Aaron K. Baughman, Cary, NC (US); Jeremy R. Fox, Georgetown, TX (US); Jennifer M. Hatfield, Portland, OR (US); Kavitha Hassan Yogaraj, Bangalore (IN)

(21) Appl. No.: 18/542,873

(22) Filed: Dec. 18, 2023

(51) Int. Cl. G06N 3/0442; G06N 3/0455; G06N 3/0499

(52) U.S. Cl. CPC G06N 3/0442; G06N 3/0455; G06N 3/0499

(57) ABSTRACT

Provided is a method, system, and computer program product for adaptatively training a large language model based on predicted changes in computing resources. A processor may identify data elements of computing resources for training a large language model. The identified data elements include a configured model topology. The processor may generate a forecast vector capturing a predicted change in the configured model topology over a time period. The processor may execute, using an optimization algorithm and the forecast vector, a series of optimization experiments using each training type of a plurality of training types to determine an optimal computing resource supply and demand over the time period. The processor may determine, based on the series of optimization experiments, an accuracy penalty value associated with each training type. The processor may train the large language model using a first training type that has a lowest accuracy penalty.

### BACKGROUND

The present disclosure relates generally to large language models (LLMs) and, more specifically, to training LLMs using training techniques that produce optimized accuracy results based on predicted availability of computing resources.

The widespread adoption and influence of foundational models, also referred to as Large Language Models (LLMs), have permeated various industries. These models facilitate a multitude of applications, including commentary generation, playwriting, article summarization, and text generation. LLMs employ a generative modeling approach that encapsulates class distributions, allowing for the creation of fresh samples. This generative method synthesizes original text or information based on acquired knowledge, incorporating various learning techniques such as supervised, semi-supervised, unsupervised, and self-supervised learning. These diverse processes enable these models to learn and adapt effectively.

In general, foundational models are trained on vast amounts of data, often reaching petabyte scales. Consider a dataset focused on sports, which amalgamates the Academic Pile and a Pile with specific sports-related information. Once a foundational model undergoes training on such extensive data, it becomes adaptable to diverse domains. This adaptability encompasses various forms:

Fine-Tuning: This process involves utilizing labeled data pertaining to a specific task to refine the model's focus on that particular problem.

Few-Shot Learning: By presenting a few instances of a specific task along with instructive clues, the model learns how to tackle the problem.

One-Shot Learning: Providing just a single example of a task alongside instructions, guiding the model on how to solve the problem.

Zero-Shot Learning: Offering instructions to the model without presenting an example solution.

In all the aforementioned learning methods, numerous parameters are adjusted to minimize the model's loss function while maximizing metrics like perplexity scores or validation rouge numbers.

### SUMMARY

Embodiments of the present disclosure include a method, system, and computer program product for adaptatively training a large language model based on predicted changes in computing resources. A processor may identify data elements of computing resources for training a large language model that includes at least one of an encoder stack and a decoder stack. The identified data elements include a configured model topology. The processor may generate a forecast vector capturing a predicted change in the configured model topology over a time period. The processor may execute, using an optimization algorithm and the forecast vector, a series of optimization experiments using each training type of a plurality of training types to determine an optimal computing resource supply and demand over the time period. The processor may determine, based on the series of optimization experiments, an accuracy penalty value associated with each training type of the plurality of training types. The processor may train the large language model using a first training type that has a lowest accuracy penalty.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example adaptive large language model system, in accordance with embodiments of the present disclosure.

FIG. 2 illustrates an example diagram of stack training types, in accordance with embodiments of the present disclosure.

FIG. 3 illustrates an example diagram for determining of a training type for adaptively training the large language model, in accordance with embodiments of the present disclosure.

FIG. 4 illustrates an example diagram for shuffling encoders over a plurality of nodes for each determined solution for training the large language model, in accordance with embodiments of the present disclosure.

FIG. 5 illustrates a flow diagram of an example process for adaptively training a large language model, in accordance with some embodiments of the present disclosure.

FIG. 6 illustrates a high-level block diagram of an example computer system that may be used in implementing one or more of the methods, tools, and modules, and any related functions, described herein, in accordance with embodiments of the present disclosure.

FIG. 7 depicts a schematic diagram of a computing environment for executing program code related to the methods disclosed herein and for adaptive large language model training according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to large language models and, more particularly, to adaptively training large language models using training techniques that produce optimized accuracy results based on predicted availability of computing resources. While the present disclosure is not necessarily limited to such applications, various aspects of the disclosure may be appreciated through a discussion of various examples using this context.

According to an aspect of the invention, there is provided a computer-implemented method comprising identifying data elements of computing resources for training a large language model that includes at least one of an encoder stack and a decoder stack, where the identified data elements comprise a configured model topology, generating a forecast vector capturing a predicted change in the configured model topology over a time period, executing, using an optimization algorithm and the forecast vector, a series of optimization experiments using each training type of a plurality of training types to determine an optimal computing resource supply and demand over the time period, determining, based on the series of optimization experiments, an accuracy penalty value associated with each training type of the plurality of training types, and training the large language model using a first training type that has a lowest accuracy penalty. This approach for adaptively training a LLM is advantageous because it allows for the efficient training of models with an encoder stack and/or a decoder stack, resulting in improved LLM performance and adaptability to different domains. Additionally, this approach for forecasting and optimizing computing resource demand and supply enhances the overall efficiency and effectiveness of the training process, leading to better accuracy and resource utilization for the LLM.

In embodiments, the configured model topology may comprise one or more attributes related to an amount of encoders, an amount of decoders, an amount of transformers, a type of attention, an amount of parallel attention, Feedforward Neural Network (FNN) hidden layers, a type of connections, an amount of add norms, and/or token number. This is advantageous because analyzing these specific attributes of the model topology allows for generating a more accurate forecast vector related to changes in the model topology over the time period.

In embodiments, the plurality of training types may comprise vertical stack training, across stack training, attention with linear biases (ALiBi) training, partially expanded fine-tuning (PEFT), and low-rank adaptation (LoRA) training. This is advantageous because each of the training types will be selected and encoded into a supply and demand network flow optimization problem that determines a best solution (e.g., based on the given training type) for training the LLM.

In embodiments, the vertical stack training is performed individually on either the encoder stack or the decoder stack of the large language model, while the across stack training is performed on both the encoder stack and decoder stack together of the large language model. This is advantageous because it allows for efficient training of the LLM regardless of whether it is applied to an encoder stack, a decoder stack, or a full transformer.

In embodiments, executing the series of optimization experiments may comprise selecting a long-short term memory (LSTM) model for the at least one of the encoder stack or the decoder stack based on the forecast vector and each training type of the plurality of training types, inputting, by the LSTM model, feature values of the forecast vector and weights of memory or past trends related to the computing resources, adjusting, by the LSTM model, demand parameters based on the feature values and each training type, inputting, by the LSTM model, a supply of computing resources based on the adjusted demand parameters and each training type and generating, based on the input and by the LSTM model, a reinforcement table comprising a plurality of solutions for training the large language model. This is advantageous because the LSTM model accepts the features as input while mixing together weights of memory or past trends. This enables the LSTM to learn over time how to better describe the encoder stack or the decoder stack while not forgetting how it changed in the past. This balances the forecasted values and historical values.

In embodiments, each solution of the plurality of solutions comprises an average compute supply and demand value, a network supply and demand value, and an accuracy penalty value. This is advantageous because using these values, the optimal solution for training the LLM can be determined based on the given training type.

In embodiments, executing the series of optimization experiments may further comprise shuffling encoders over a plurality of nodes of the computing resources for each solution of the plurality of solutions. This is advantageous because the shuffling action will move demand across the supply to search for optimal dividing of the encoder/decoder onto a grid of nodes. Based on the shuffling, the best solution can be determined for training the LLM and spread across the node for fine tuning.

In embodiments, the predicted change in the configured model topology is based on one or more computing resource trends. This is advantageous because the predicted change captures the trends of data science engineers as they change the network. If the stack is projected to get bigger, the forecasted vector will capture that increasing size.

In embodiments, the configured model topology may be analyzed using a FNN classifier. This is advantageous because the FNN classifier acts as the final layer for making predictions or classifications based on the representations learned by the underlying encoder stack, decoder stack and/or transformer architecture.

According to an aspect of the invention, there is provided a system comprising a processor and a computer-readable storage medium communicatively coupled to the processor and storing program instructions which, when executed by the processor, cause the processor to perform a method. The method performed by the processor comprises: identifying data elements of computing resources for training a large language model that includes at least one of an encoder stack and a decoder stack, where the identified data elements comprise a configured model topology, generating a forecast vector capturing a predicted change in the configured model topology over a time period, executing, using an optimization algorithm and the forecast vector, a series of optimization experiments using each training type of a plurality of training types to determine an optimal computing resource supply and demand over the time period, determining, based on the series of optimization experiments, an accuracy penalty value associated with each training type of the plurality of training types, and training the large language model using a first training type that has a lowest accuracy penalty. This approach for adaptively training a LLM is advantageous because it allows for the efficient training of models with an encoder stack and/or a decoder stack, resulting in improved LLM performance and adaptability to different domains. Additionally, this approach for forecasting and optimizing computing resource demand and supply enhances the overall efficiency and effectiveness of the training process, leading to better accuracy and resource utilization for the LLM.

In embodiments, executing the series of optimization experiments, which is performed by the processor of the system, may comprise selecting a long-short term memory (LSTM) model for the at least one of the encoder stack or the decoder stack based on the forecast vector and each training type of the plurality of training types, inputting, by the LSTM model, feature values of the forecast vector and weights of memory or past trends related to the computing resources, adjusting, by the LSTM model, demand parameters based on the feature values and each training type, inputting, by the LSTM model, a supply of computing resources based on the adjusted demand parameters and each training type and generating, based on the input and by the LSTM model, a reinforcement table comprising a plurality of solutions for training the large language model. This is advantageous because the LSTM model accepts the features as input while mixing together weights of memory or past trends. This enables the LSTM to learn over time how to better describe the encoder stack or the decoder stack while not forgetting how it changed in the past. This balances the forecasted values and historical values.

In embodiments, executing the series of optimization experiments, which is performed by the processor of the system, may further comprise shuffling encoders over a plurality of nodes of the computing resources for each solution of the plurality of solutions. This is advantageous because the shuffling action will move demand across the supply to search for optimal dividing of the encoder/decoder onto a grid of nodes. Based on the shuffling, the best solution can be determined for training the LLM and spread across the node for fine tuning.

According to an aspect of the invention, there is provided a computer program product comprising a computer-readable storage medium having program instructions embodied therewith, the program instructions executable by a processor to cause the processor to perform a method. The method performed by the processor comprises: identifying data elements of computing resources for training a large language model that includes at least one of an encoder stack and a decoder stack, where the identified data elements comprise a configured model topology, generating a forecast vector capturing a predicted change in the configured model topology over a time period, executing, using an optimization algorithm and the forecast vector, a series of optimization experiments using each training type of a plurality of training types to determine an optimal computing resource supply and demand over the time period, determining, based on the series of optimization experiments, an accuracy penalty value associated with each training type of the plurality of training types, and training the large language model using a first training type that has a lowest accuracy penalty. This approach for adaptively training a LLM is advantageous because it allows for the efficient training of models with an encoder stack and/or a decoder stack, resulting in improved LLM performance and adaptability to different domains. Additionally, this approach for forecasting and optimizing computing resource demand and supply enhances the overall efficiency and effectiveness of the training process, leading to better accuracy and resource utilization for the LLM.

In embodiments, the program instructions executable by the processor for executing the series of optimization experiments, may comprise selecting a long-short term memory (LSTM) model for the at least one of the encoder stack or the decoder stack based on the forecast vector and each training type of the plurality of training types, inputting, by the LSTM model, feature values of the forecast vector and weights of memory or past trends related to the computing resources, adjusting, by the LSTM model, demand parameters based on the feature values and each training type, inputting, by the LSTM model, a supply of computing resources based on the adjusted demand parameters and each training type and generating, based on the input and by the LSTM model, a reinforcement table comprising a plurality of solutions for training the large language model. This is advantageous because the LSTM model accepts the features as input while mixing together weights of memory or past trends. This enables the LSTM to learn over time how to better describe the encoder stack or the decoder stack while not forgetting how it changed in the past. This balances the forecasted values and historical values.

In embodiments, the program instructions executable by the processor for executing the series of optimization experiments executing the series of optimization experiments, which is performed by the processor of the system, may further comprise shuffling encoders over a plurality of nodes of the computing resources for each solution of the plurality of solutions. This is advantageous because the shuffling action will move demand across the supply to search for optimal dividing of the encoder/decoder onto a grid of nodes. Based on the shuffling, the best solution can be determined for training the LLM and spread across the node for fine tuning.

It is noted that the growth in the size of Large Language Models (LLMs) has been staggering. Initially starting with BERT in 2019, which had 340 million parameters, subsequent models like GPT-2020 in 2020 escalated to 175 billion parameters. By 2023, these models have ballooned to 100 trillion parameters. This exponential increase in model size has corresponded to enhanced capabilities and performance, enabling models to effectively handle zero-shot learning across a wide array of tasks.

However, training these models has become exceedingly challenging. The creation of foundational models has become prohibitively difficult, necessitating the use of hundreds of Graphics Processing Units (GPUs). For instance, to train a sandstone model with 3 billion parameters, International Business Machines (IBM)'s Vela® GPU computing cluster was employed. IBM Vela® is a trademark registered to IBM and/or their affiliates.

Furthermore, the process of fine-tuning has become arduous due to the sheer size of parameters. Backpropagation for error correction and gradients has become computationally expensive. To mitigate these challenges, various approaches have emerged, such as Parameter Efficient Fine Tuning (PEFT) and Low Rank Adaptation of LLM (LoRA).

PEFT is a fine-tuning strategy used in transfer learning scenarios. It involves training only a subset of the parameters in a pre-trained model while keeping the remaining parameters fixed. The idea is to selectively unfreeze and update a portion of the pre-trained model's layers, usually the higher or task-specific layers, while keeping the lower layers or the general knowledge intact. This approach aims to prevent catastrophic forgetting and leverage the pre-trained knowledge in a more focused manner for the specific downstream task. By partially expanding the fine-tuning process to a smaller subset of the model's parameters, PEFT allows for faster adaptation to new tasks while retaining the advantages of the pre-trained model's general knowledge.

LoRA is a technique that focuses on adapting large pre-trained language models to new tasks more efficiently by reducing the model's size while maintaining performance. The method involves reducing the rank of attention and feedforward matrices in the transformer architecture. The rank reduction is done in a way that aims to maintain most of the essential information while significantly reducing the number of parameters. By lowering the rank of these matrices, LoRA effectively compresses the model, reducing its computational and memory requirements while attempting to preserve its ability to perform well on specific tasks.

Both PEFT and LoRA selectively train smaller sets of weights or introduce additional weight layers without requiring the retraining of billions of parameters. Additionally, algorithms like Alibi (Attention with Linear Biases) expand the number of tokens usable within a model through extrapolation, avoiding the need to train specific sections of the model. ALiBi is a technique proposed to enhance the attention mechanism in transformer-based models. The standard attention mechanism allows the model to focus on different parts of the input sequence. ALiBi extends this by adding linear biases to the attention scores. These linear biases are learnable parameters that are added to the dot products between query and key vectors before applying the softmax function. They help the model to explicitly control the attention distribution, which could be useful in various tasks, especially where specific patterns or relations need to be highlighted or suppressed. The addition of these linear biases gives the model more control over the attention mechanism, allowing it to focus on or ignore certain parts of the input sequence based on the task requirements.

As GPU technology evolves, the type, size, and number of GPUs required for these operations continue to dynamically change. When this occurs, the type of training algorithms should adapt to optimize the objective function without having to approximate training methods. The present disclosure attempts to solve the optimization problem with a technical solution.

Embodiments of the present disclosure provide for utilizing long-short-term memory (LLM) models using multiple different types of training strategies, such as stack training, across stack training, and Partially Expanded Fine-Tuning (PEFT). The system operates by collecting and analyzing initial data elements such as the configured model topology, selecting a training type, generating a forecast vector that captures changes in model topology over a time period and memory or past trend weights, then running a series of optimization experiments to determine the optimal computing resource demand and supply along with the accuracy penalty that best suits a user needs. The system may provide the user with optimization results of shuffling the encoders across nodes, the network requests and supplies, as well as the fine-tuning model parameters.

In embodiments, various training types may be selected such as: divide and conquer training within vertical stacks of transformers, divide and conquer training across vertical stacks of transformers, joint foundational and forecasted domain adaptation, forecasting domain adaptation type, in domain adaptation migration, training adaptation selection, and scenario based simulation of training models.

In embodiments, divide and conquer training within vertical stacks of transformers includes breaking down the training process into smaller, manageable segments within the vertical stacks of transformers (e.g., either the encoder or decoder stack of the transformer). Transformers, which are integral components in models like BERT or GPT, consist of multiple layers. In embodiments, divide and conquer training within these stacks focuses on optimizing and training each layer or set of layers individually, allowing for more efficient and effective fine-tuning or adaptation.

In embodiments, similar to the previous approach above, divide and conquer training across vertical stacks of transformers involves breaking down the training process. However, instead of focusing on individual layers within the stacks (e.g., encoder or decoder stack), it divides the training process across different sets of transformers. This strategy aims to optimize the interaction and communication between different stacks of transformers within a model, enhancing overall performance.

In embodiments, joint foundational and forecasted domain adaptation combines foundational training, which involves training the model on extensive and diverse datasets, with forecasted domain adaptation. In embodiments, forecasted domain adaptation refers to the preparation or adaptation of the model for specific future domains or scenarios. This joint method ensures that the model not only has a solid foundation but also anticipates and adapts to forthcoming domains or changes in the data landscape.

In embodiments, forecasting domain adaptation type includes identifying and categorizing different types or categories of domain shifts or changes that might occur in the future. Forecasting domain adaptation type aims to predict and prepare the model for potential adaptations needed to maintain optimal performance when faced with these anticipated changes.

In embodiments, in-domain adaptation migration includes seamlessly transitioning or migrating the model's learned knowledge, representations, or parameters from one specific domain to another within the same overarching domain. It involves strategies to efficiently transfer and adapt the knowledge learned from one subset of data to another closely related subset within the same domain.

In embodiments, training adaptation selection includes selecting or determining the most appropriate adaptation strategy or technique based on the specific requirements, characteristics, or challenges presented by the data or the domain. It includes the evaluation and selection of adaptation methods tailored to the unique needs of the training process.

In embodiments, scenario-based simulation of training models includes creating hypothetical scenarios or situations that mimic real-world conditions or changes in the data landscape. By simulating various training conditions, this approach allows for the evaluation and refinement of training models under diverse circumstances, preparing the models to adapt effectively to these scenarios in actual deployment.

These training methodologies represent diverse strategies aimed at optimizing model performance, adaptability, and preparation for various domains or shifts in data characteristics.

In this way, embodiments of the present disclosure utilize various training strategies, (e.g., stack training, across stack training, and PEFT), to provide significant advantages in training LLM models. These strategies allow for the efficient training of models with both encoder and decoder stacks, resulting in improved LLM model performance and adaptability to different domains. Additionally, the present disclosure's approach of forecasting and optimizing computing resource demand and supply enhances the overall efficiency and effectiveness of the training process, leading to better accuracy and resource utilization.

The aforementioned advantages are example advantages, and not all advantages are discussed. Furthermore, embodiments of the present disclosure can exist that contain all, some, or none of the aforementioned advantages while remaining within the spirit and scope of the present disclosure.

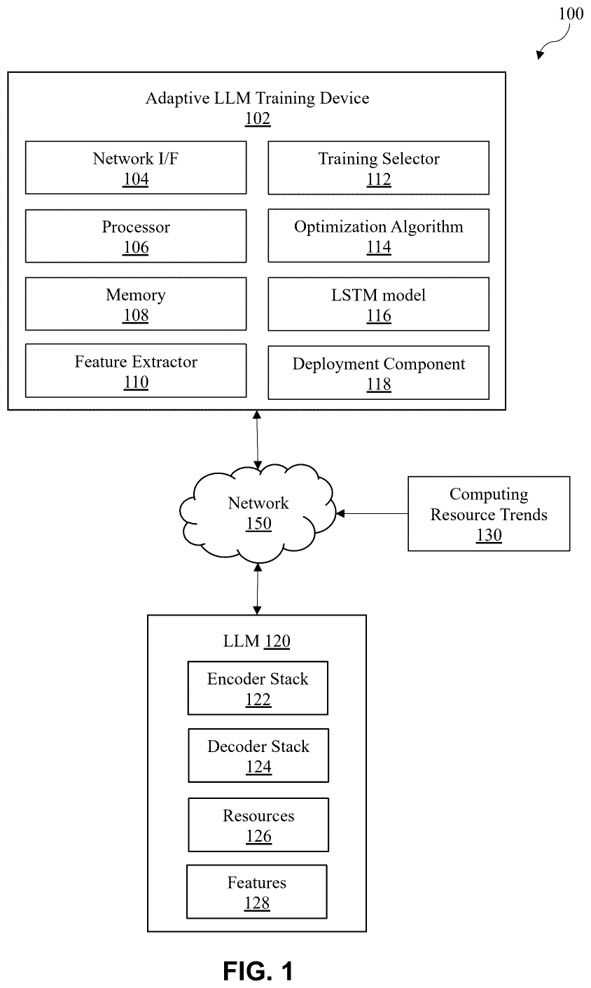

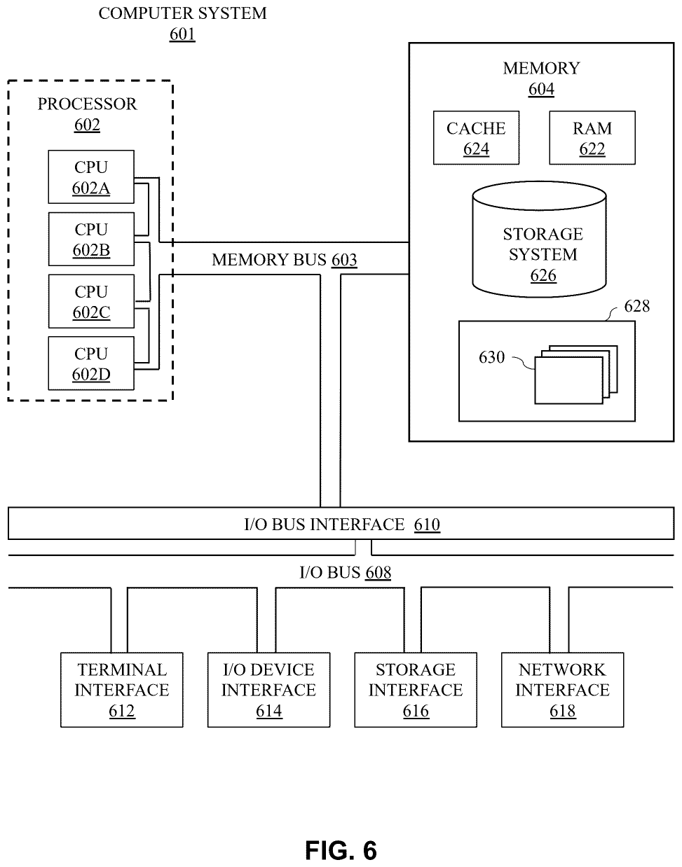

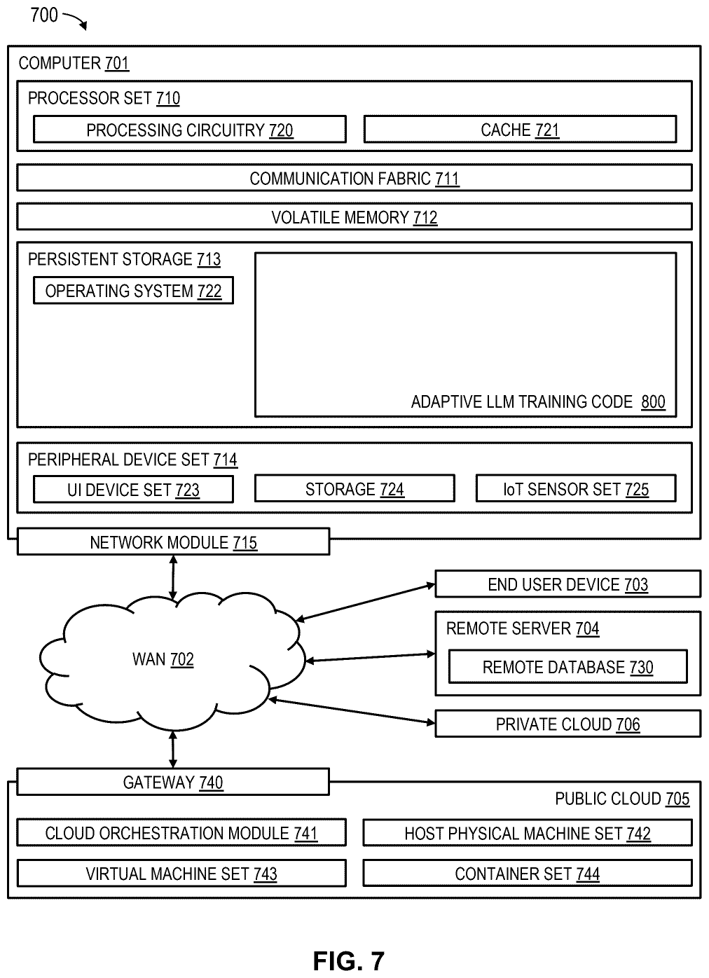

With reference now to FIG. 1, shown is a block diagram of an example adaptive large language model (LLM) system 100, in accordance with embodiments of the present disclosure. In the illustrated embodiment, adaptive LLM system 100 includes adaptive LLM training device 102 that is communicatively coupled to LLM 120 and computing resource trends 130 via network 150. Adaptive LLM training device 102 may be configured as any type of computer system and may be substantially similar to computer system 601 detailed in FIG. 6. LLM 120 may be configured as any type of computer system and include components similar to computer system 601 and/or 700 as described in FIG. 7. In embodiments, LLM 120 may be any type of computer system configured to perform LLM processes, e.g., a supercomputer comprising multiple nodes, where each nodes includes multiple GPUs, multiple drives, etc. Computing resource trends 130 may be any type of data indicating changes in computing resources related to the LLM topology 120. For example, computing resource trends 130 captures the trends of data science engineers as they change the network topology over time to accommodate advances in LLM applications/technology.

Network 150 may be any type of communication network, such as a wireless network or a cloud computing network. Network 150 may be substantially similar to, or the same as, a computing environment 700 described in FIG. 7. In some embodiments, network 150 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over network 150. In some embodiments, network 150 can be implemented using any number of any suitable communications media. For example, the network may be a wide area network (WAN), a local area network (LAN), a personal area network (PAN), an internet, or an intranet. In certain embodiments, the various systems may be local to each other, and communicate via any appropriate local communication medium.

In embodiments, LLM 120 may include encoder stack 122, decoder stack 124, resources 126, and features 128 or attributes. In some embodiments, LLM 120 may only include at least one of the encoder stack 122 or the decoder stack 124. In some embodiments, LLM 120 may include both encoder stack 122 and decoder stack 124, e.g., a full transformer. In embodiments, resources 126 may include computer resources required by the LLM 120. Resources 126 may include various computer systems (e.g., GPU size and memory requirements available), bandwidth, disk flops and disk size, etc. Features 128 may comprise various data related to the amount or number of encoders/decoders in the stacks, type of attention, number of parallel attention, FNN hidden layers, number of add norms, type of connections, token number, training type applied/used by (e.g., use of alibi, LoRA, PEFT, etc.) of the given LLM 120.

In embodiments, features 128 may include historical data features (past data) and/or current data features (real-time data) related to the LLM 120. As would be recognized by one of ordinary skill in the art, other features may be extracted depending on the type of LLM, and the examples given herein should not be construed as limiting. In some embodiments, LLM 120 may include some or similar components (e.g., processor, memory, algorithms, etc.) as adaptive LLM training device 102, but for brevity purposes these components are not shown.

In the illustrated embodiment, adaptive LLM training device 102 includes network interface (I/F) 104, processor 106, memory 108, feature extractor 110, training selector 112, optimization algorithm 114, long short-term memory (LSTM) model 116, and deployment component 118.

In embodiments, feature extractor 110 is configured collect, extract, receive, and/or analyze features 128 to determine a configured model topology of LLM 120 at a specific time period. In some embodiments, the feature extractor 128 may be configured as an FNN classifier. In embodiments, the configured model topology may also be determined based on features related to the encoder stack 122, the decoder stack 124, and computing resources 126. For example, in the case where only the encoder stack is utilized, the feature extractor 110 quantifies the topology of the encoders such as number of encoders, type of attention, number of parallel attention, FNN hidden layers, number of add norms, type of connections, token number, use of alibi, and etc. These features 128 are time indexed at a specific time. In embodiments, these features 128 may be forecasted in time into the future. In embodiments, the features extractor 110 may utilize computing resource trends 130 in relation to the extracted features to generate a forecast feature vector. In this way, the trends of data science engineers are captured as changes in the network topology are applied to the LLM 120. For example, if the encoder or decoder stack (or other computing resources 126) is projected to get bigger over a time period, the forecasted vector will capture that predicted increase in size.

In embodiments, training selector 112 is configured to select a training type for training the LLM 120 from a plurality of training types. The plurality of training types may include vertical stack training, across stack training, attention with linear biases (ALiBi) training, partially expanded fine-tuning (PEFT), low-rank adaptation (LoRA) training, and the like. In embodiments, vertical stack training is performed individually on either the encoder stack 122 or the decoder stack 124 of the LLM 120, and across stack training is performed on both the encoder stack 122 and decoder stack 124 together of LLM 120.

In embodiments, optimization algorithm 114 is configured to determine a best supply and demand solution for the LLM 120 based on a given selected training technique and the predicted computing resources 126 over a forecasted time period. For example, the demand of the algorithm is changed based on the selection of training type. For example, if PEFT is selected, the requirements of GPU will be reduced by the fraction of the weights that will be updated. However, this will be at the expense of accuracy. In embodiments, a penalty of validation will be managed in a reinforcement table. The optimization algorithm 114 is configured to minimize both the penalty of validation and the demand of computing resources when determining the solution to the optimization problem.

In embodiments, LSTM model 116 is composed of memory cells and gates that regulate the flow of information within the network. Each memory cell holds and updates information across time steps. In embodiments, the gates-input gate, forget gate, and output gate-manage the flow of information into and out of the memory cell, controlling the retention and forgetting of information at each time step. LSTM model 116 is configured to process sequences by considering the context of previous elements in the sequence, where it handles sequences of variable lengths and maintain memory across long sequences, allowing them to capture dependencies over extended distances.

In embodiments, LSTM model 116 is configured to learn over time how to better describe the encoder stack 122 and/or decoder 124 while not forgetting how it changed in the past. This balances the forecasted values and historical values. In embodiments, the LSTM model 116 is configured to determine the GPU size requirements, GPU memory requirements, memory requirements, network bandwidth need, disk flops, disk size, etc. based on the forecast vector. The demand of computing resources is sent to the supply and demand optimization algorithm 114.

In embodiments, the supply of the computing resources 126 will be determined by worker node management nodes (not shown). The supply determines how much of the resources 126 can be allocated to a given task. The resources 126 will be marked as dirty until the optimization algorithm 114 determines which set of training parameters to use. In embodiments, each of the training types will be selected by the training selector 112 and encoded into a supply and demand network flow optimization problem solved by the optimization algorithm 114.

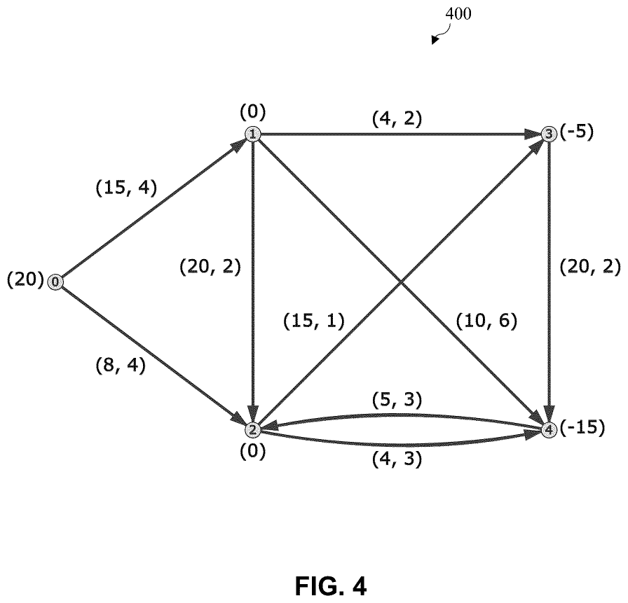

In embodiments, the demand of the computing training along with the minimization of the accuracy penalty will be calculated for each selected training type. This sets up for a network flow optimization. In embodiments, the optimization algorithm 114 will shuffle encoders over the nodes for each candidate solution (as described in FIG. 4). The shuffling action will move demand across the supply to find search for optimal dividing of the encoder onto the grid. The set of candidate solutions will each have an average compute demand and supply, network demand and supply, and an accuracy penalty. In embodiments, iteration continues for each of the training types to get n number possible candidate solutions for m number training types. In embodiments, the best solution for solving the optimization problem is picked and the model is deployed and spread across the node for fine tuning by deployment component 118.

In some embodiments, the adaptive LLM training device 102 may use machine learning to continuously run rounds of experiments to generate additional useful training data. For example, when a new set of inputs (such as new data features or inputs collected/received after implementing the optimized training solutions on the current state of the system 100) are presented to the machine learning model, it may prescribe training types based on the past actions for similar inputs. As the training data expands, the machine learning model is periodically retrained and/or refactored, resulting in increasingly accurate predictions of valid configuration parameter values that are likely to affect performance metrics of the LLM 120 based on predicted changes in computing resources 126. The results from prior experimentation may be used to determine configuration and/or workload attribute variations and/or training type selections from which to gather data for future experiments. For example, using machine learning may identify one or more experimental values for one or more configuration parameters based on determining that historical changes to the one or more configuration parameters had an impact on one or more performance metrics that is over a threshold amount of change. For example, the machine learning model may identify historical changes for language prediction parameters based on given training selection and optimize such parameters over time.

In some embodiments, adaptive LLM training device 102 can utilize machine learning and/or deep learning, where algorithms or models can be generated by performing supervised, unsupervised, or semi-supervised training on historical data inputs and/or historical features. Machine learning algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

FIG. 1 is intended to depict the representative major components of adaptive LLM training system 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with adaptive LLM training system 100 may not be present, and the arrangement of components may vary. For example, while FIG. 1 illustrates an example adaptive LLM training system 100 having a single adaptive LLM training device 102 and a single LLM 120 that are communicatively coupled via a single network 150, suitable network architectures for implementing embodiments of this disclosure may include any number of adaptive LLM training devices, LLMs, and networks. The various models, modules, systems, and components illustrated in FIG. 1 may exist, if at all, across a plurality of adaptive LLM training devices, LLMs, and networks.

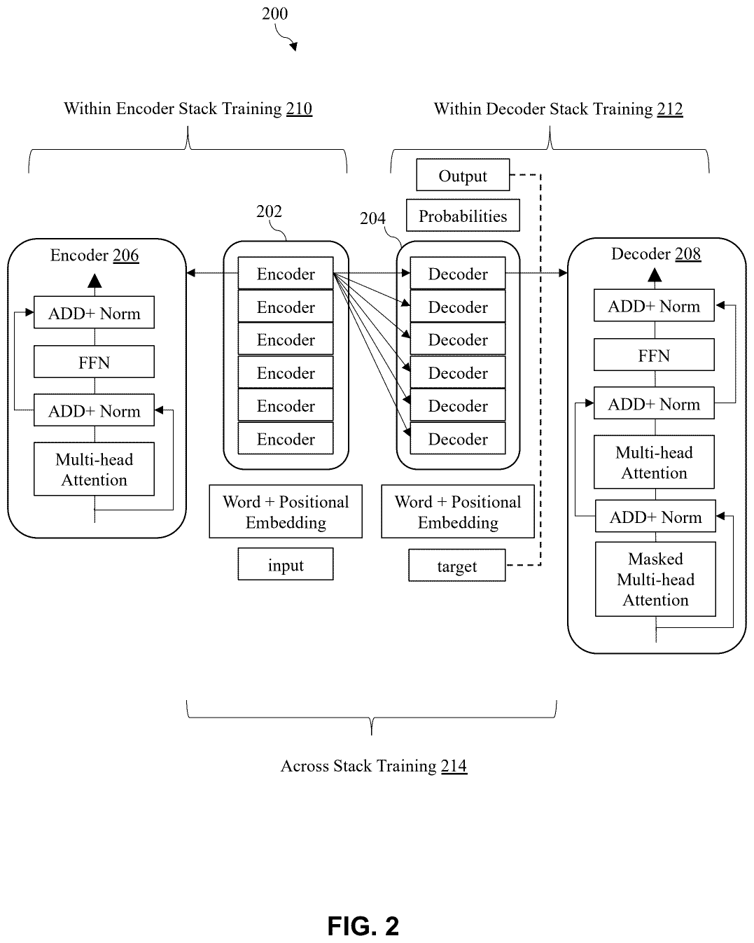

Referring now to FIG. 2, shown is an example diagram 200 of stack training types, in accordance with embodiments of the present disclosure. In the illustrated embodiment, encoder stack 202 comprises a plurality of encoders. Encoder 206 is an example diagram of each encoder of the plurality of encoders of encoder stack 202. Encoder 206 is responsible for processing and understanding input data. It typically involves converting text or sequences of words into a format that the model can work with. This process involves several layers of neural network units. Each layer extracts different features or aspects of the input text, building a hierarchical representation of the text. In the context of a language model, the encoder is designed to learn the relationships between words or tokens in a sequence. It captures the contextual information and the dependencies within the input data. The final output of the encoder is a condensed representation of the input sequence that holds important information for the model to understand and process.

In the illustrated embodiment, encoder 206 includes terms ADD+ Norm, FNN, and Multi-head Attention. The term “ADD+ Norm” generally refers to a residual connection combined with layer normalization. In the transformer architecture, residual connections, also known as skip connections, are employed to address the vanishing gradient problem in deep neural networks. These connections allow the original input of a layer to be added to the output of the layer. This approach helps the network retain information from the original input during training, allowing for easier training of very deep networks. Layer normalization, on the other hand, normalizes the activations of the neurons in a layer. This process helps in stabilizing the learning process and accelerates convergence.

Within the transformer's encoder, a feedforward neural network (FNN) is used. This component consists of a series of fully connected layers. The FNN in the encoder processes the output from the multi-head attention mechanism (explained below). It usually consists of two linear transformations with a non-linear activation function in between, such as ReLU (Rectified Linear Unit). The feedforward network's role is to capture complex patterns in the encoded representations and help the model learn more abstract features from the input data.

Multi-head attention is a fundamental component of the transformer architecture used in the encoder. It allows the model to focus on different parts of the input sequence simultaneously. This mechanism computes attention multiple times in parallel, each focusing on different parts of the input sequence. The attention mechanism helps the model understand the relationships between different words in the sequence. Specifically, multi-head attention splits the input into multiple parts, performs separate attention operations in parallel on these parts, and then combines the results. This parallel processing enables the model to capture different relationships and dependencies in the input sequence, providing a more robust and comprehensive understanding of the context.

In summary, within the encoder of a transformer model, ADD+ Norm refers to residual connections combined with layer normalization, the FNN is a feedforward neural network processing information from multi-head attention, and multi-head attention allows the model to analyze and capture relationships between different parts of the input sequence concurrently. These components collectively contribute to the model's ability to learn and represent complex patterns in the data efficiently.

Decoder stack 204 comprises a plurality of decoders, where each decoder may be configured as decoder 208. Similar to their function in the encoder 206, “ADD+ Norm” in the decoder refers to the use of residual connections along with layer normalization. Residual connections enable the flow of the original input information through the decoder layers, aiding in the prevention of vanishing gradients. Layer normalization ensures that the activations within the decoder are standardized, contributing to more stable and efficient training.

In the decoder 208 of a transformer model, the feedforward neural network (FNN) serves a similar purpose as in the encoder. This component processes the output of the attention mechanism within the decoder. The FNN generally consists of multiple layers of linear transformations followed by non-linear activation functions. Its role is to capture complex patterns and features from the attention mechanism's output, aiding in generating the output sequence.

Within the decoder 208, multi-head attention is used to focus on different parts of the input sequence and capture interdependencies between words. In the decoder, this attention mechanism differs slightly from the encoder's multi-head attention. In the decoder, attention typically has two main components: the encoder-decoder attention and the masked self-attention. The encoder-decoder attention allows the decoder to focus on relevant parts of the input sequence generated by the encoder. It helps the decoder align with the input to produce the output sequence. The masked self-attention in the decoder ensures that during the generation process, each position in the output sequence can only attend to earlier positions, preventing the model from “cheating” by looking at future words when predicting the current word in an autoregressive manner.

This is a specific form of multi-head attention used in the decoder 208 that employs masking to prevent positions in the decoder's self-attention from attending to subsequent positions. This masking ensures that during language generation tasks, the model attends only to earlier positions in the output sequence, maintaining the autoregressive nature of the generation process.

In summary, within the decoder 208 of a transformer model, ADD+ Norm incorporates residual connections and layer normalization, the FNN processes information from the attention mechanism, multi-head attention includes both encoder-decoder attention and masked self-attention, and masked multi-head attention specifically prevents the decoder's attention from looking ahead in the output sequence during autoregressive generation. These components collectively contribute to the decoder's ability to generate meaningful output sequences based on the learned representations and relationships from the input data.

In the context of encoder stack 202 and decoder stack 204 within a transformer-based architecture, word positional embeddings play a crucial role in helping the model understand the sequence of words and their positions in a sentence or input sequence.

In the encoder 206 of a transformer architecture, along with word embeddings (which represent the meaning of each word), positional embeddings are added to the word embeddings to convey the position of words in the input sequence. Unlike recurrent neural networks (RNNs) where the order of input is implicit due to the sequential nature of processing, transformers lack this inherent sequential understanding. Positional embeddings are added to the word embeddings to impart information about the position or order of words in the input sequence. These embeddings could be created, for instance, using trigonometric functions, learned parameters, or other positional encoding schemes to maintain the sequential information.

Similarly, in the decoder 208 of a transformer, positional embeddings serve a crucial function. The decoder needs to understand the relative positions of the words in the generated output sequence to properly predict the next words. However, during the generation process, the decoder processes words sequentially and needs to know the position of each word in the output sequence. Similar to the encoder, the decoder also incorporates positional embeddings along with word embeddings to indicate the position of words in the generated sequence.

These positional embeddings provide the necessary information for the model to differentiate between words based on their positions in the sequence. They enable the model to understand the sequential order of words in both the input and output sequences, which is crucial for tasks like language translation, summarization, and sequence generation.

In embodiments, within encoder stack training 210 is defined as utilizing the selected training type on the encoder stack 202 of the LLM. In embodiments, within decoder stack training 212 is defined as utilizing the selected training type on the decoder stack 212 of the LLM. In embodiments, across stack training 214 is defined as utilizing the selected training type for training both the encoder stack 202 and the decoder stack 204 together. This is only applicable for those LLM's that have both stacks of encoders and decoders (e.g., a full transformer). For example, in the case where only the encoder stack is utilized, a feature extractor (e.g., feature extractor 110) quantifies the topology of the encoder stack 202 such as number of encoders, type of attention, number of parallel attention, FNN hidden layers, number of add norms, type of connections, token number, training type (e.g., use of alibi) and the like. These features are time indexed at a specific time. These features are forecasted in time into the future. This captures the trends of data science engineers as they change the network. If the stack is projected to get bigger, the forecasted vector will capture that increasing size.

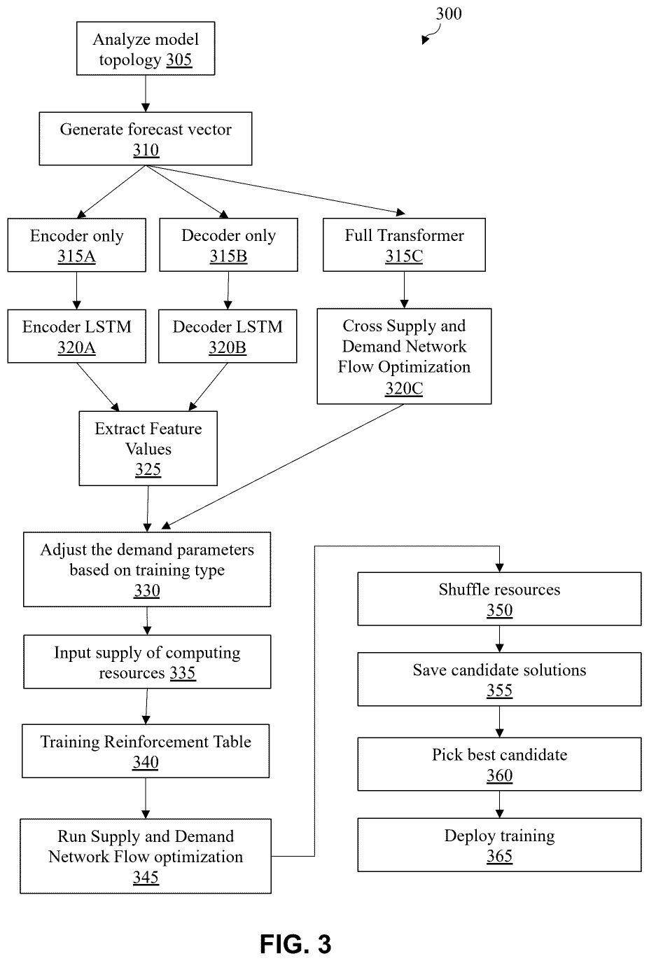

Referring now to FIG. 3, shown is an example diagram 300 for determining a training type to adaptively train the large language model, in accordance with embodiments of the present disclosure. In embodiments, adaptive LLM training device 102 of FIG. 1 may perform the steps the illustrated method 300.

In embodiments, process 300 begins by analyzing the LLM model topology. This is illustrated at 305. For example, a feature extractor may collect, extract, receive, and/or analyze features to determine a configured model topology of the LLM at a specific time period. The configured model topology may also be determined based on features related to the encoder stack, the decoder stack, and/or available computing resources.

The process 300 continues by generating a forecast vector. This is illustrated at step 310. For example, the features extractor may utilize computing resource trends (e.g., trends in computer engineering related to LLM models/systems) in relation to the extracted features to generate a forecast feature vector. In this way, the trends of data science engineers are captured as changes in the network topology are applied to the LLM. For example, if the encoder or decoder stack (or other computing resources) is projected to get bigger over a time period, the forecasted vector will capture that predicted increase in size.

The process 300 continues by determining if the training is within stack training for an encoder stack only (at step 315A), a decoder stack only (at step 315B), or across stack training of a full transformer (at step 315C). If encoder stack only (315A), an encoder LSTM model (at step 320A) extracts feature values associated with the encoder stack of the LLM, computing resources, and forecast vector. If decoder stack only (315B), a decoder LSTM model (at step 320B) extracts feature values associated with the encoder stack of the LLM, computing resources, and forecast vector.

The LSTM model learns over time how to better describe the encoder stack and/or decoder stack while not forgetting how it changed in the past. This balances the forecasted values and historical values. The LSTM model determines the GPU size requirements, GPU memory requirements, memory requirements, network bandwidth need, disk flops, disk size, etc. based on the forecast vector, where the demand of computing resources is used by the supply and demand optimization algorithm of step 345.

If a full transformer (315C), e.g., the model topology has both encoder and decoders, then two cross supply demand network flow optimizations are run (at step 320C). Then a third optimization links the two networks together to fine tune the cross weights, wherein the cost is the average cost over both stages of optimization while the accuracy penalty is the average over both optimizers.

The process 300 continues by adjusting the demand parameters based on the selected training type (e.g., vertical stack training, across stack training, attention with linear biases (ALiBi) training, partially expanded fine-tuning (PEFT), and low-rank adaptation (LoRA) training). This is illustrated at step 330. For example, if PEFT is selected, the requirements of GPU will be reduced by the fraction of the weights that will be updated. However, this will be at the expense of accuracy. In embodiments, a penalty of validation will be managed in a reinforcement table (generated at step 340).

The process 300 continues by inputting the supply of computing resources. This is illustrated at step 335. In embodiments, the supply of the computing resources will be determined by one or more worker node management nodes. The supply determines how much of the resources can be allocated to the task. The resources will be marked as dirty until the algorithm determines which set of training parameters to use.

The process 300 continues by generating a training reinforcement table. This is illustrated at step 340. The training reinforcement table maps accuracy penalty values related to the selected training types.

The process 300 continues by running the supply and demand network flow optimization. This is illustrated at step 345. The supply and demand network flow optimization may utilize an optimization algorithm, wherein the optimization algorithm is configured to minimize both the penalty of validation and the demand of computing resources when determining the solution to the optimization problem. Each of the selected training types will be encoded into a supply and demand network flow optimization problem.

The process 300 continues by shuffling resources across nodes of the LLM to determine the best solutions based on a plurality of solution resulting from applying the selected training type. This is illustrated at step 350. Shuffling resources across nodes is further described in FIG. 4 below. The optimization algorithm will shuffle encoders over the nodes for each candidate solution. The shuffling action will move demand across the supply to find search for optimal dividing of the encoder onto the grid. The set of candidate solutions will each have an average compute demand and supply, network demand and supply, and an accuracy penalty.

The process 300 continues by saving the plurality of solutions. This is illustrated at step 355. The process 300 continues by selecting the best solution from the plurality of solutions based on a lowest accuracy penalty. This is illustrated at step 360.

The process 300 deploying the selected solution on the LLM. This is illustrated at step 365. In this way, the process 300 uses various training techniques (e.g., stack training, across stack training, and PEFT) to provide significant advantages in training adaptive large language models. These strategies allow for enhanced customization and adaptability to different applications and domains. By considering various training types and optimizing computing resource demand and supply, the present disclosure achieves improved model performance and efficiency. The present disclosure provides a comprehensive and flexible framework for training adaptive large language models across a broader range of applications.

Referring now to FIG. 4, shown is an example diagram 400 for shuffling encoders over a plurality of nodes for each determined solution for training the large language model, in accordance with embodiments of the present disclosure. In the illustrated embodiment, the nodes of the computing grid are labeled as 0 to 4. The cost on each node will be determined by the split of number of encoders that run on each node. The demand may be negative, which is optimal because that means there are free resources while the positive ones mean the node is overtaxed. The numbers in parenthesis depict the network demand, x, and the second number shows the compromise in accuracy based on the training type algorithm and the number of encoders that will be trained.

In embodiments, the optimization algorithm will shuffle encoders over the nodes for each candidate solution. The shuffling action will move demand across the supply to find search for optimal dividing of the encoder onto the grid. The set of candidate solutions will each have an average compute demand and supply, network demand and supply, and an accuracy penalty.

This iteration continues for each of the training types to get n number possible candidate solutions for m number training types. The best solution is selected and the model is deployed and spread across the node for fine tuning.

The following is example code for shuffling encoders across nodes as shown in FIG. 4:
import numpy as np
from ortools.graph.python import min_cost_flow
# Instantiate a SimpleMinCostFlow solver.
smcf=min_cost_flow.impleMinCostFlow( )
# Define four parallel arrays: sources, destinations, capacities,
# and unit costs between each pair. For instance, the arc from node 0
# to node 1 has a capacity of 15.
start_nodes=np.array([0, 0, 1, 1, 1, 2, 2, 3, 4])
end_nodes=np.array([1, 2, 2, 3, 4, 3, 4, 4, 2])
capacities=np.array([15, 8, 20, 4, 10, 15, 4, 20, 5])
unit_costs=np.array([4, 4, 2, 2, 6, 1, 3, 2, 3])
# Define an array of supplies at each node.
supplies=[20, 0, 0, −5, −15]
# Add arcs, capacities and costs in bulk using numpy.
all_arcs=smcf.add_arcs_with_capacity_and_unit_cost(
start_nodes, end_nodes, capacities, unit_costs)
# Add supply for each nodes.
smcf.set_nodes_supplies(np.arange(0, len(supplies)), supplies)
# Find the min cost flow.
status=smcf.solve( )
if status!=smcf.OPTIMAL:
   print(‘There was an issue with the min cost flow input.’)
   print(f‘Status: {status}’)
   exit(1)
print(f‘Minimum cost: {smcf.optimal_cost( )}’)
print(”)
print(‘Arc Flow/Capacity Cost’)
solution_flows=smcf.flows(all_arcs)
costs=solution_flows*unit_costs
for arc, flow, cost in zip(all_arcs, solution_flows, costs):
   print(
   f‘{smcf.tail(arc):1}->{smcf.head(arc)} {flow:3}/{smcf.capacity (arc):3} {cost}’
   )

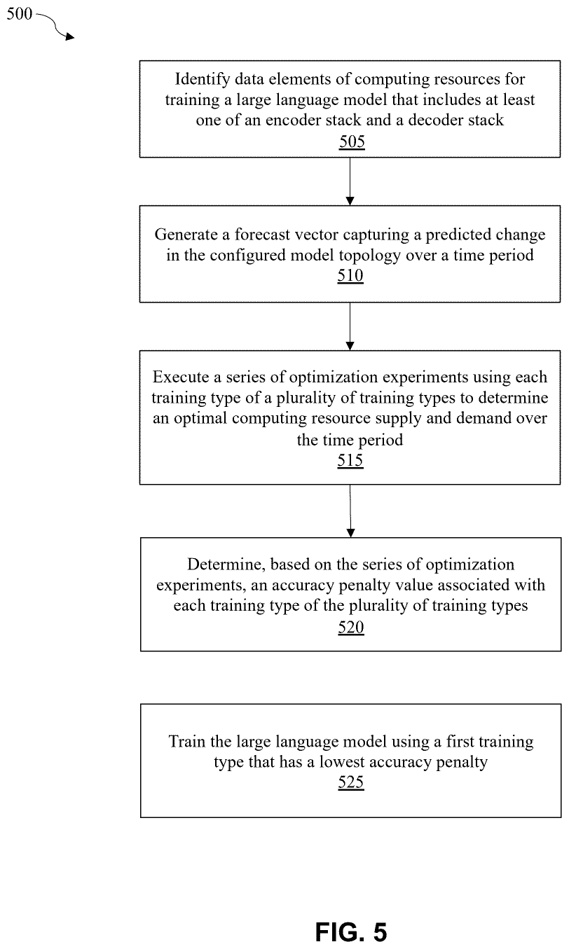

Referring now to FIG. 5, shown is an example process 500 for adaptively training a large language model, in accordance with some embodiments of the present disclosure. The process 500 may be performed by processing logic that comprises hardware (e.g., circuitry, dedicated logic, programmable logic, microcode, etc.), software (e.g., instructions run on a processor), firmware, or a combination thereof. In some embodiments, the process 500 is a computer-implemented process. In embodiments, the process 500 may be performed by processor 106 of adaptive LLM training device 102 exemplified in FIG. 1.

The process 500 begins by identifying data elements of computing resources for training a large language model that includes at least one of an encoder stack and a decoder stack. This is illustrated at step 505.

The process 500 continues by generating a forecast vector capturing a predicted change in the configured model topology over a time period. This is illustrated at step 510. In embodiments, the model topology comprises one or more attributes related to an amount of encoders, an amount of decoders, an amount of transformers, a type of attention, an amount of parallel attention, FNN hidden layers, a type of connections, an amount of add norms, and token number. In some embodiments, the predicted change in the configured model topology is based on one or more computing resource trends. In some embodiments, the configured model topology is analyzed using a FNN classifier.

The process 500 continues by executing, using an optimization algorithm and the forecast vector, a series of optimization experiments using each training type of a plurality of training types to determine an optimal computing resource supply and demand over the time period. This is illustrated at step 515. In embodiments, the plurality of training types include vertical stack training, across stack training, attention with linear biases (ALiBi) training, partially expanded fine-tuning (PEFT), low-rank adaptation (LoRA) training, joint foundational and forecasted domain adaptation, forecasting domain adaptation type, in domain adaptation migration, training adaptation selection, and scenario based simulation of training models.

In some embodiments, executing the series of optimization experiments may include selecting a long-short term memory (LSTM) model for the at least one of the encoder stack or the decoder stack based on the forecast vector and each training type of the plurality of training types; inputting, by the LSTM model, feature values of the forecast vector and weights of memory or past trends related to the computing resources; adjusting, by the LSTM model, demand parameters based on the feature values and each training type; inputting, by the LSTM model, a supply of computing resources based on the adjusted demand parameters and each training type; and generating, based on the input and by the LSTM model, a reinforcement table comprising a plurality of solutions for training the large language model.

In some embodiments, each solution of the plurality of solutions comprises an average compute supply and demand value, a network supply and demand value, and an accuracy penalty value.

In some embodiments, executing the series of optimization experiments further comprises shuffling encoders over a plurality of nodes of the computing resources for each solution of the plurality of solutions.

The process 500 continues by determining, based on the series of optimization experiments, an accuracy penalty value associated with each training type of the plurality of training types. This is illustrated at step 520.

The process 500 continues by training the large language model using a first training type that has a lowest accuracy penalty. This is illustrated at step 525. In embodiments, the results may be provided to the user with results of shuffling the encoders across nodes, the network requests and supplies, as well as the fine-tuning model parameters.

In this way, the present disclosure uses various training techniques, such as stack training, across stack training, and PEFT, to provide significant advantages in training adaptive large language models. These strategies allow for enhanced customization and adaptability to different applications and domains. By considering various training types and optimizing computing resource demand and supply, the present disclosure achieves improved model performance and efficiency. The present disclosure provides a comprehensive and flexible framework for training adaptive large language models across a broader range of applications.

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache. In some embodiments, a processor can include at least one or more of, a memory controller, and/or storage controller. In some embodiments, the CPU can execute the processes included herein (e.g., process 300 and 500 as described in FIG. 3 and FIG. 5, respectively). In some embodiments, the computer system 601 may be configured as adaptive LLM training system 100 of FIG. 1.

System memory subsystem 604 may include computer system readable media in the form of volatile memory, such as random-access memory (RAM) 622 or cache memory 624. Computer system 601 may further include other removable/non-removable, volatile/non-volatile computer system data storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 604 can include flash memory, e.g., a flash memory stick drive or a flash drive. Memory devices can be connected to memory bus 603 by one or more data media interfaces. The memory subsystem 604 may include at least one program product having a set (e.g., at least one) of program modules that are configured to carry out the functions of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single units, the computer system 601 may, in some embodiments, contain multiple I/O bus interfaces 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

One or more programs/utilities 628, each having at least one set of program modules 630 may be stored in memory subsystem 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 628 and/or program modules 630 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

Embodiments of the present disclosure may be implemented together with virtually any type of computer, regardless of the platform is suitable for storing and/or executing program code. FIG. 7 shows, as an example, a computing environment 700 (e.g., cloud computing system) suitable for executing program code related to the methods disclosed herein and for adaptive LLM training and management. In some embodiments, the computing environment 700 may be the same as or an implementation of the computing environment 100.

Computing environment 700 contains an example of an environment for the execution of at least some of the computer code involved in performing the inventive methods, such as adaptive LLM training code 800. The adaptive LLM training code 800 may be a code-based implementation of the adaptive LLM system 100. In addition to adaptive LLM training code 800, computing environment 700 includes, for example, a computer 701, a wide area network (WAN) 702, an end user device (EUD) 703, a remote server 704, a public cloud 705, and a private cloud 706. In this embodiment, the computer 701 includes a processor set 710 (including processing circuitry 720 and a cache 721), a communication fabric 711, a volatile memory 712, a persistent storage 713 (including operating a system 722 and the adaptive LLM training code 800, as identified above), a peripheral device set 714 (including a user interface (UI) device set 723, storage 724, and an Internet of Things (IoT) sensor set 725), and a network module 715. The remote server 704 includes a remote database 730. The public cloud 705 includes a gateway 740, a cloud orchestration module 741, a host physical machine set 742, a virtual machine set 743, and a container set 744.

The computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 730. As is well understood in the art of computer technology, and depending upon the technology, performance of a computer-implemented method may be distributed among multiple computers and/or between multiple locations. On the other hand, in this presentation of the computing environment 700, detailed discussion is focused on a single computer, specifically the computer 701, to keep the presentation as simple as possible. The computer 701 may be located in a cloud, even though it is not shown in a cloud in FIG. 7. On the other hand, the computer 701 is not required to be in a cloud except to any extent as may be affirmatively indicated.

The processor set 710 includes one, or more, computer processors of any type now known or to be developed in the future. The processing circuitry 720 may be distributed over multiple packages, for example, multiple, coordinated integrated circuit chips. The processing circuitry 720 may implement multiple processor threads and/or multiple processor cores. The cache 721 is memory that is located in the processor chip package(s) and is typically used for data or code that should be available for rapid access by the threads or cores running on the processor set 710. Cache memories are typically organized into multiple levels depending upon relative proximity to the processing circuitry. Alternatively, some, or all, of the cache for the processor set may be located “off chip.” In some computing environments, the processor set 710 may be designed for working with qubits and performing quantum computing.

Computer readable program instructions are typically loaded onto the computer 701 to cause a series of operational steps to be performed by the processor set 710 of the computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 721 and the other storage media discussed below. The program instructions, and associated data, are accessed by the processor set 710 to control and direct performance of the inventive methods. In the computing environment 700, at least some of the instructions for performing the inventive methods may be stored in the adaptive LLM training code 800 in the persistent storage 713.

The communication fabric 711 is the signal conduction path that allows the various components of the computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 712 is any type of volatile memory now known or to be developed in the future. Examples include dynamic type random access memory (RAM) or static type RAM. Typically, the volatile memory 712 is characterized by random access, but this is not required unless affirmatively indicated. In the computer 701, the volatile memory 712 is located in a single package and is internal to the computer 701, but, alternatively or additionally, the volatile memory may be distributed over multiple packages and/or located externally with respect to the computer 701.

The persistent storage 713 is any form of non-volatile storage for computers that is now known or to be developed in the future. The non-volatility of this storage means that the stored data is maintained regardless of whether power is being supplied to the computer 701 and/or directly to the persistent storage 713. The persistent storage 713 may be a read only memory (ROM), but typically at least a portion of the persistent storage allows writing of data, deletion of data and re-writing of data. Some familiar forms of persistent storage include magnetic disks and solid state storage devices. The operating system 722 may take several forms, such as various known proprietary operating systems or open source Portable Operating System Interface-type operating systems that employ a kernel. The code included in the adaptive LLM training code 800 typically includes at least some of the computer code involved in performing the inventive methods.

The peripheral device set 714 includes the set of peripheral devices of the computer 701. Data communication connections between the peripheral devices and the other components of the computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 723 may include components such as a display screen, speaker, microphone, wearable devices (such as goggles and smart watches), keyboard, mouse, printer, touchpad, game controllers, and haptic devices. The storage 724 is external storage, such as an external hard drive, or insertable storage, such as an SD card. The storage 724 may be persistent and/or volatile. In some embodiments, the storage 724 may take the form of a quantum computing storage device for storing data in the form of qubits. In embodiments where the computer 701 is required to have a large amount of storage (for example, where the computer 701 locally stores and manages a large database) then this storage may be provided by peripheral storage devices designed for storing very large amounts of data, such as a storage area network (SAN) that is shared by multiple, geographically distributed computers. The IoT sensor set 725 is made up of sensors that can be used in Internet of Things applications. For example, one sensor may be a thermometer and another sensor may be a motion detector.

The network module 715 is the collection of computer software, hardware, and firmware that allows the computer 701 to communicate with other computers through the WAN 702. The network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 715 are performed on the same physical hardware device. In other embodiments (for example, embodiments that utilize software-defined networking (SDN)), the control functions and the forwarding functions of the network module 715 are performed on physically separate devices, such that the control functions manage several different network hardware devices. Computer readable program instructions for performing the inventive methods can typically be downloaded to the computer 701 from an external computer or external storage device through a network adapter card or network interface included in the network module 715.

The WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 703 is any computer system that is used and controlled by an end user (for example, a customer of an enterprise that operates the computer 701) and may take any of the forms discussed above in connection with the computer 701. The EUD 703 typically receives helpful and useful data from the operations of the computer 701. For example, in a hypothetical case where the computer 701 is designed to provide a recommendation to an end user, this recommendation would typically be communicated from the network module 715 of the computer 701 through the WAN 702 to the EUD 703. In this way, the EUD 703 can display, or otherwise present, the recommendation to an end user. In some embodiments, the EUD 703 may be a client device, such as thin client, heavy client, mainframe computer, desktop computer and so on.

The remote server 704 is any computer system that serves at least some data and/or functionality to the computer 701. The remote server 704 may be controlled and used by the same entity that operates computer 701. The remote server 704 represents the machine(s) that collect and store helpful and useful data for use by other computers, such as the computer 701. For example, in a hypothetical case where the computer 701 is designed and programmed to provide a recommendation based on historical data, then this historical data may be provided to the computer 701 from the remote database 730 of the remote server 704.

The public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 705 is performed by the computer hardware and/or software of the cloud orchestration module 741. The computing resources provided by the public cloud 705 are typically implemented by virtual computing environments that run on various computers making up the computers of the host physical machine set 742, which is the universe of physical computers in and/or available to the public cloud 705. The virtual computing environments (VCEs) typically take the form of virtual machines from the virtual machine set 743 and/or containers from the container set 744. It is understood that these VCEs may be stored as images and may be transferred among and between the various physical machine hosts, either as images or after instantiation of the VCE. The cloud orchestration module 741 manages the transfer and storage of images, deploys new instantiations of VCEs and manages active instantiations of VCE deployments. The gateway 740 is the collection of computer software, hardware, and firmware that allows the public cloud 705 to communicate through the WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 706 is similar to the public cloud 705, except that the computing resources are only available for use by a single enterprise. While the private cloud 706 is depicted as being in communication with the WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 705 and the private cloud 706 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 722 and the adaptive LLM training code 800 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying data elements of computing resources for training a large language model that includes at least one of an encoder stack and a decoder stack, wherein the identified data elements comprise a configured model topology;
generating a forecast vector capturing a predicted change in the configured model topology over a time period;
executing, using an optimization algorithm and the forecast vector, a series of optimization experiments using each training type of a plurality of training types to determine an optimal computing resource supply and demand over the time period;
determining, based on the series of optimization experiments, an accuracy penalty value associated with each training type of the plurality of training types; and
training the large language model using a first training type that has a lowest accuracy penalty.

2. The method of claim 1, wherein the configured model topology comprises one or more attributes related to an amount of encoders, an amount of decoders, an amount of transformers, a type of attention, an amount of parallel attention, Feedforward Neural Network (FNN) hidden layers, a type of connections, an amount of add norms, and token number.

3. The method of claim 1, wherein the plurality of training types comprises: vertical stack training, across stack training, attention with linear biases (ALiBi) training, partially expanded fine-tuning (PEFT), and low-rank adaptation (LoRA) training.

4. The method of claim 3, wherein the vertical stack training is performed individually on either the encoder stack or the decoder stack of the large language model, and wherein the across stack training is performed on both the encoder stack and decoder stack together of the large language model.

5. The method of claim 1, wherein executing the series of optimization experiments comprises:
selecting a long-short term memory (LSTM) model for the at least one of the encoder stack or the decoder stack based on the forecast vector and each training type of the plurality of training types;
inputting, by the LSTM model, feature values of the forecast vector and weights of memory or past trends related to the computing resources;
adjusting, by the LSTM model, demand parameters based on the feature values and each training type;
inputting, by the LSTM model, a supply of computing resources based on the adjusted demand parameters and each training type; and
generating, based on the input and by the LSTM model, a reinforcement table comprising a plurality of solutions for training the large language model.

6. The method of claim 5, wherein each solution of the plurality of solutions comprises an average compute supply and demand value, a network supply and demand value, and an accuracy penalty value.

7. The method of claim 1, wherein executing the series of optimization experiments further comprises shuffling encoders over a plurality of nodes of the computing resources for each solution of the plurality of solutions.

8. The method of claim 1, wherein the predicted change in the configured model topology is based on one or more computing resource trends.

9. The method of claim 1, wherein the configured model topology is analyzed using a FNN classifier.

10. A system comprising:
a processor; and
a computer-readable storage medium communicatively coupled to the processor and storing program instructions which, when executed by the processor, cause the processor to perform a method comprising:
identifying data elements of computing resources for training a large language model that includes at least one of an encoder stack and a decoder stack, wherein the identified data elements comprise a configured model topology;
generating a forecast vector capturing a predicted change in the configured model topology over a time period;
executing, using an optimization algorithm and the forecast vector, a series of optimization experiments using each training type of a plurality of training types to determine an optimal computing resource supply and demand over the time period;
determining, based on the series of optimization experiments, an accuracy penalty value associated with each training type of the plurality of training types; and
training the large language model using a first training type that has a lowest accuracy penalty.

11. The system of claim 10, wherein the configured model topology comprises one or more attributes related to an amount of encoders, an amount of decoders, an amount of transformers, a type of attention, an amount of parallel attention, FNN hidden layers, a type of connections, an amount of add norms, and token number.

12. The system of claim 10, wherein the plurality of training types comprises: vertical stack training, across stack training, attention with linear biases (ALiBi) training, partially expanded fine-tuning (PEFT), and low-rank adaptation (LoRA) training.

13. The system of claim 12, wherein the vertical stack training is performed individually on either the encoder stack or the decoder stack of the large language model, and wherein the across stack training is performed on both the encoder stack and decoder stack together of the large language model.

14. The system of claim 1, wherein executing the series of optimization experiments comprises:
selecting a long-short term memory (LSTM) model for the at least one of the encoder stack or the decoder stack based on the forecast vector and each training type of the plurality of training types;
inputting, by the LSTM model, feature values of the forecast vector and weights of memory or past trends related to the computing resources;
adjusting, by the LSTM model, demand parameters based on the feature values and each training type;
inputting, by the LSTM model, a supply of computing resources based on the adjusted demand parameters and each training type; and
generating, based on the input and by the LSTM model, a reinforcement table comprising a plurality of solutions for training the large language model.

15. The system of claim 14, wherein each solution of the plurality of solutions comprises an average compute supply and demand value, a network supply and demand value, and an accuracy penalty value.

16. The system of claim 10, wherein executing the series of optimization experiments further comprises shuffling encoders over a plurality of nodes of the computing resources for each solution of the plurality of solutions.

17. A computer program product comprising a computer-readable storage medium having program instructions embodied therewith, the program instructions executable by a processor to cause the processor to perform a method comprising:
identifying data elements of computing resources for training a large language model that includes at least one of an encoder stack and a decoder stack, wherein the identified data elements comprise a configured model topology;
generating a forecast vector capturing a predicted change in the configured model topology over a time period;
executing, using an optimization algorithm and the forecast vector, a series of optimization experiments using each training type of a plurality of training types to determine an optimal computing resource supply and demand over the time period;
determining, based on the series of optimization experiments, an accuracy penalty value associated with each training type of the plurality of training types; and
training the large language model using a first training type that has a lowest accuracy penalty.

18. The computer program product of claim 17, wherein the configured model topology comprises one or more attributes related to an amount of encoders, an amount of decoders, an amount of transformers, a type of attention, an amount of parallel attention, FNN hidden layers, a type of connections, an amount of add norms, and token number.

19. The computer program product of claim 17, wherein the plurality of training types comprises: vertical stack training, across stack training, attention with linear biases (ALiBi) training, partially expanded fine-tuning (PEFT), and low-rank adaptation (LoRA) training.

20. The computer program product of claim 19, wherein the vertical stack training is performed individually on either the encoder stack or the decoder stack of the large language model, and wherein the across stack training is performed on both the encoder stack and decoder stack together of the large language model.
